(19) United States
(12) Patent Application Publication
(10) Pub. No.: US 2012/0255341 A1
(43) Pub. Date: Oct. 11, 2012

(54) CHROMATOGRAPH

(75) Inventors: Yuichi NOZAKA, Tokyo (JP); Takashi MATSUURA, Tokyo (JP)

(73) Assignee: YOKOGAWA ELECTRIC CORPORATION, Tokyo (JP)

(21) Appl. No.: 13/440,105

(22) Filed: Apr. 5, 2012

(30) Foreign Application Priority Data
Apr. 5, 2011 (JP) 2011-083609

(51) Int. Cl. G01N 30/02

(52) U.S. Cl. 73/23.35

(57) ABSTRACT

There is provided a chromatograph. The chromatograph includes: at least two analysis modules. Each of the analysis modules includes: a column that separates components of a sample; and a detector that detects the components separated by the column. Each of the analysis modules analyzes the sample in an analysis cycle that is set for each of the analysis modules.

This application claims priority from Japanese Patent Application No. 2011-083609, filed on Apr. 5, 2011, the entire contents of which are herein incorporated by reference.

### BACKGROUND

1. Technical Field

Embodiments described herein relate to a chromatograph and, more specifically, to increase of the analysis speed in the chromatograph.

2. Related Art

Chromatography is widely used as a method for separating and analyzing components contained in a multi-component sample.

In chromatography, a multi-component sample is moved through a column which is filled with a stationary phase from its one end together with a mobile phase. As the sample travels through the column, components are separated in the form of different movement speeds which are caused by different distributions between the mobile phase and the stationary phase which result from differences in absorptivity and solubility in the stationary phase. The individual components can be identified by comparing the movement speeds with movement speeds of standard substances.

An instrument used for chromatography is called a chromatograph, and a graph showing how individual components have been separated is called a chromatogram.

A method which uses a gas as the mobile phase is gas chromatography. Example columns used in gas chromatography are a filled column in which a metal pipe, for example, is filled with a powder and a capillary column in which the inner surface of a narrow tube made of quartz, for example, is coated with a liquid stationary phase. Capillary columns are used widely because of their high separation performance.

On the other hand, a method which uses a liquid as the mobile phase is liquid chromatography. Liquid chromatography is classified into paper chromatography which uses filter paper as the stationary phase, thin layer chromatography which uses, for example, a silica gel thin layer formed on a glass plate as the stationary phase, a column chromatography which uses a column which is filled with, for example, silica gel as the stationary phase, etc. An instrument which is configured so as to be capable of high-speed analysis by applying high pressure to a column is called a high-speed liquid chromatograph.

In paper chromatography and thin layer chromatography, a mobile phase is moved because of the capillary phenomenon. The column chromatography which uses an ion exchange resin as the stationary phase is called ion exchange chromatography, and the column chromatography which uses porous gel as the stationary phase is called gel permeation chromatography.

FIG. 5 shows a general configuration of a conventional gas chromatograph. As shown in FIG. 5, a mobile phase 1 is supplied from a high-pressure gas cylinder and introduced into a column 4 via a flow rate controller 2 and a sample injector 3.

An inert gas such as N₂ or He is used as the mobile phase 1. The flow rate controller 2 controls the flow rate of the mobile phase 1 that is introduced into the column 4. A target sample is selected from plural (m) kinds of samples by a sample selector 5 and the selected sample is injected into the sample injector 3 by a prescribed amount. If the sample is not vaporized, the sample injector 3 is heated so that individual components of the sample will be vaporized.

The column 4 is filled with a stationary phase that is suitable for the sample. To keep the sample in a vaporized state, the column 4 is housed in a thermostat oven 6 whose temperature is kept at a prescribed high temperature. The individual components of the sample are separated in the column 4.

The individual components of the sample that have been separated in the column 4 are introduced into a detector 7 sequentially. A detector that is suitable for a subject of analysis and a purpose of analysis, such as of a thermal conductivity type, a flame ionization type, an electron capture type, or a flame photometry type, is used as the detector 7.

An output signal of the detector 7 is converted into a digital signal and input to a computation controller 8, where the signal is subjected to data processing that is necessary for display of analysis results on a display unit 9. The sample that has been introduced into the detector 7 is exhausted.

Analysis conditions, computation conditions for data processing, a display form of the display unit 9, etc. are set and input to the computation controller 8 through an operation receiver 10. The computation controller 8 supervises the individual units of the instrument according to the thus-set conditions.

JP-A-5-5729 discloses a technique that relates to an ion chromatograph which is composed of modules.

However, in the conventional configuration shown in FIG. 5, only one sample can be analyzed at a time. To analyze plural samples, it is necessary to analyze the samples one by one in a manner shown in a timing chart of FIG. 6. It takes long time to analyze a large number of samples.

As shown in a timing chart of FIG. 7, there are samples which contain a component A which is separated early (e.g., in 3 minutes from injection) in the column 4 and a component B which is separated late ((e.g., in 10 minutes from injection). However, when such a sample is analyzed, the analysis cycle of a chromatograph is set so as to be suitable for the late separation component B. This means another problem that it also takes long time to obtain an analysis result of the early separation component A.

### SUMMARY

Exemplary embodiments of the present invention address the above disadvantages and other disadvantages not described above. However, the present invention is not required to overcome the disadvantages described above, and thus, an exemplary embodiment of the present invention may not overcome any disadvantage.

An illustrative aspect of the present invention is to realize a chromatograph which can shorten the analysis time of plural samples and the analysis times of early separation components.

According to one or more illustrative aspects of the present invention, there is provided a chromatograph. The chromatograph includes: at least two analysis modules. Each of the analysis modules includes: a column that separates components of a sample; and a detector that detects the components separated by the column. Each of the analysis modules analyzes the sample in an analysis cycle that is set for each of the analysis modules.

According to one or more illustrative aspects of the present invention, there is provided a chromatograph. The chromatograph comprises: a first analysis module configured to analyze a first sample in a first cycle, the first analysis module comprising: a first column that separates components of the first sample; and a first detector that detects the components separated by the first column, a second analysis module configured to analyze a second sample in a second cycle different from the first cycle, the second analysis module comprising: a second column that separates components of the second sample; and a second detector that detects the components separated by the second column.

Other aspects and advantages of the present invention will be apparent from the following description, the drawings and the claims.

### BRIEF DESCRIPTION OF THE DRAWINGS

FIG. 1 shows the configuration of a gas chromatograph according to an embodiment of the present invention;

FIGS. 2A-2C are timing charts showing an example operation of the gas chromatograph shown in FIG. 1;

FIGS. 3A-3C are timing charts showing another example operation of the gas chromatograph shown in FIG. 1;

FIG. 4 shows the configuration of part of a gas chromatograph according to another embodiment of the invention;

FIG. 5 shows a general configuration of a conventional gas chromatograph;

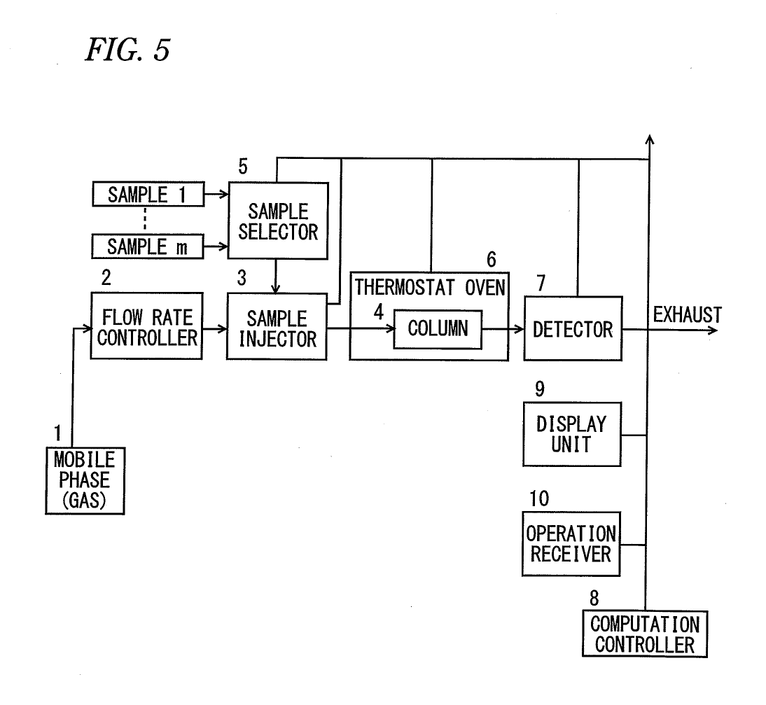

FIG. 6 is a timing chart illustrating an example operation of the chromatograph of FIG. 5; and

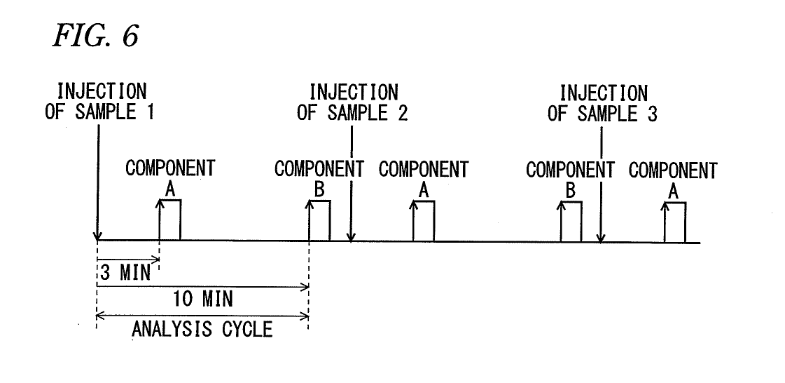

FIG. 7 is a timing chart illustrating another example operation of the chromatograph of FIG. 5.

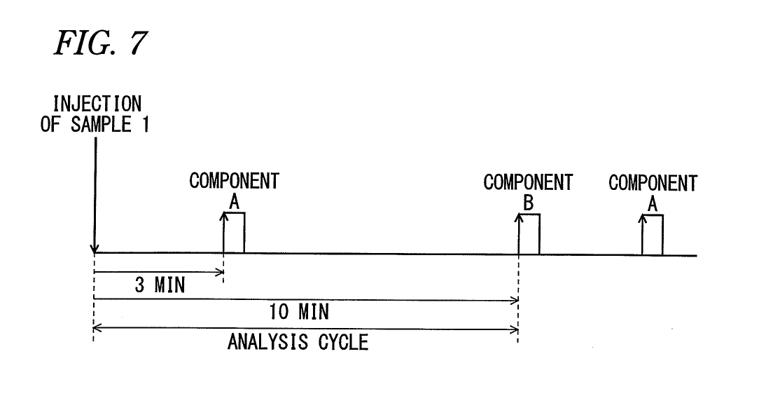

### DETAILED DESCRIPTION OF EXEMPLARY EMBODIMENTS

Exemplary embodiments of the present invention will be hereinafter described in detail with reference to the drawings.

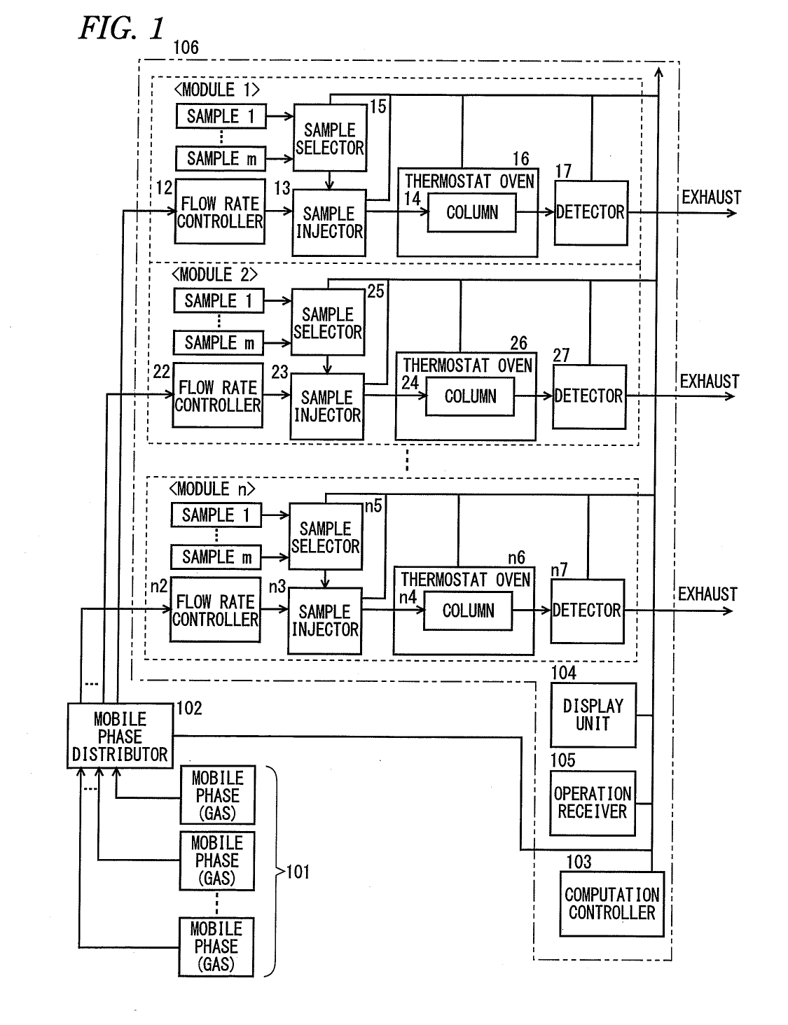

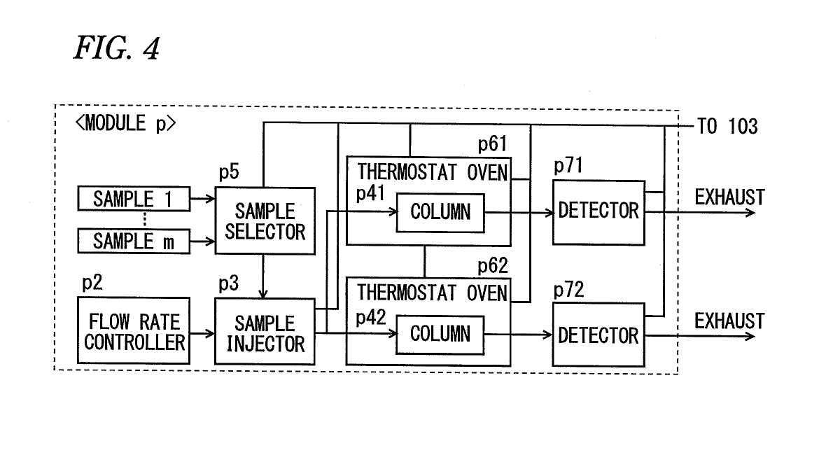

FIG. 1 shows the configuration of a gas chromatograph according to an embodiment of the invention. Although this embodiment is directed to a gas chromatograph as in the case of the above-described conventional example, the invention is not limited to such a case and can be applied to various kinds of chromatographs. In FIG. 1, blocks that are enclosed by broken lines are analysis modules 1-n, each of which has one analysis unit which consists of a column for separating, components of a sample and a detector for detecting the components separated by the column. Each of the analysis modules 1-n is configured in approximately the same manner as the gas chromatograph shown in FIG. 4.

That is, in the analysis module 1, for example, one of mobile phases 101 is supplied from a high-pressure gas cylinder and introduced into a column 14 after passing through a mobile phase distributor 102, a flow rate controller 12, and a sample injector 13 in this order.

As in the conventional example, an inert gas such as N₂ or He is used as each mobile phase 101. A mobile phase 101 that is suitable for a sample and a purpose of analysis is selected by the mobile phase distributor 102 and introduced into the flow rate controller 12. The flow rate controller 12 controls the flow rate of the mobile phase 101 that is introduced into the column 14. The target sample is selected from plural (m) kinds of samples by a sample selector 15 and is injected into the sample injector 13 by a prescribed amount. If the sample is not vaporized, the sample injector 13 is heated so that individual components of the sample will be vaporized.

The column 14 is filled with a stationary phase that is suitable for the sample. To keep the sample in a vaporized state, the column 14 is housed in a thermostat oven 16 whose temperature is kept at a prescribed high temperature. The individual components of the sample are separated in the column 14.

The individual components of the sample that have been separated in the column 14 are introduced into a detector 17 sequentially. A detector that is suitable for a subject of analysis and a purpose of analysis, such as of a thermal conductivity type, a flame ionization type, an electron capture type, or a flame photometry type, is used as the detector 17.

An output signal of the detector 17 is converted into a digital signal and input to a computation controller 103, where the signal is subjected to data processing that is necessary for display of analysis results on a display unit 104. The sample that has been introduced into the detector 17 is exhausted. The column 14 and the detector 17 constitute the analysis unit of the analysis module 1.

Analysis conditions, computation conditions for data processing, a display form of the display unit 104 are set and input to the computation controller 103 through an operation receiver 105. The computation controller 8 supervises the analysis modules 1-n so that they analyze samples in cycles set for the respective analysis modules 1-n according to the thus-set conditions.

The analysis modules 1-n, the computation controller 103, the display unit 104, and the operation receiver 105 may be housed in a common case (housing) 106 (enclosed by a two-dot chain line) and integrated together. The analysis modules 1-n are configured so as to be able to be detached individually.

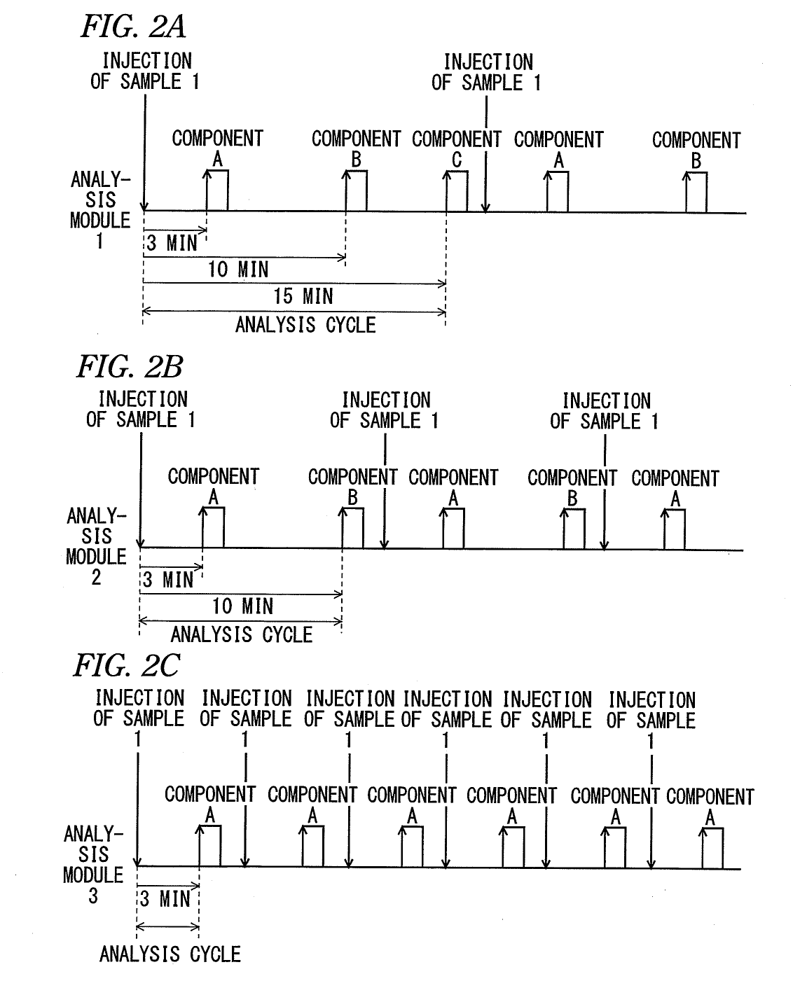

FIGS. 2A-2C are timing charts showing a specific example operation of the gas chromatograph shown in FIG. 1. That is, FIGS. 2A-2C show operations of the analysis modules 1-3, respectively. A common sample 1 is introduced into the analysis modules 1-3.

It is assumed that the common sample 1 contains components A-C which are separated in the column 14 in 3 minutes, 10 minutes, and 15 minutes, respectively. The analysis module 1 performs an analysis operation with its analysis cycle set at 15 minutes which is the separation time of the component C. The analysis module 2 performs an analysis operation with its analysis cycle set at 10 minutes which is the separation time of the component B. The analysis module 3 performs an analysis operation with its analysis cycle set at 3 minutes which is the separation time of the component A.

Since as described above the common sample 1 is introduced parallel into the three analysis modules 1-3 which perform analysis operations in cycles set for the respective analysis modules 1-3, the time taken to analyze the component B can be reduced to 10 minutes from the conventional time of 15 minutes and the time taken to analyze the component A can be reduced to 3 minutes from the conventional time of 15 minutes. The component A can be analyzed five times repeatedly by the analysis module 3 while the component C is analyzed by the analysis module 1.

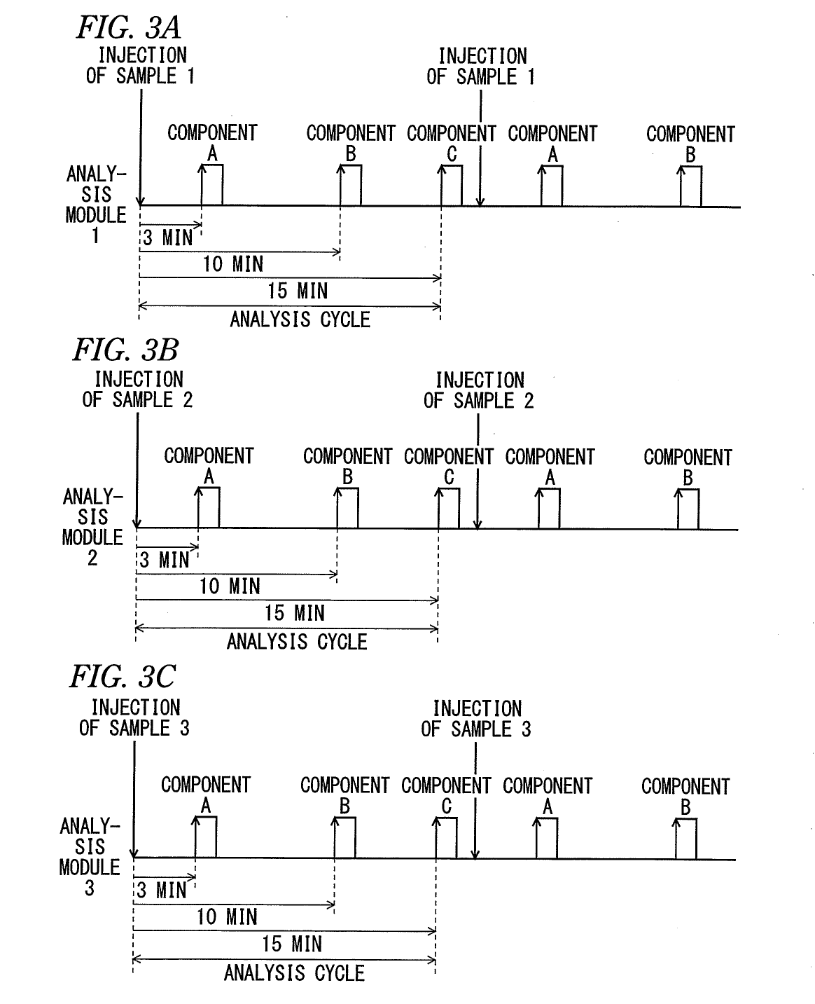

FIGS. 3A-3C are timing charts showing another specific example operation of the gas chromatograph shown in FIG. 1. That is, FIGS. 3A-3C show operations of the analysis modules 1-3, respectively. Different samples 1-3 containing the same components A-C are introduced into the respective analysis modules 1-3, and the analysis modules 1-3 perform analysis operations parallel and simultaneously.

Since the analysis modules 1-3 operate in the manner shown in FIGS. 3A-3C, all of the three different samples 1-3 can be analyzed in 15 minutes in contrast to the fact that it takes the conventional gas chromatograph 45 (3×15) minutes to analyze all the samples 1-3. That is, the total time taken to analyze all the samples 1-3 can be shortened by a factor of 3.

As described above, since the single gas chromatograph is equipped with the plural analysis modules 1-n, plural samples can be analyzed parallel and simultaneously and hence the total time taken to analyze all the samples can be shortened greatly.

Furthermore, analysis cycles can be set individually for the plural respective analysis modules 1-n which constitute the single gas chromatograph. The times taken to analyze early separation components can be shortened greatly by, for example, analyzing the same samples in the thus-set respective analysis cycles parallel and simultaneously.

Although in the embodiment only the columns 14-n4 are housed in the thermostat ovens 16-n6 of the analysis modules 1-n, respectively, the detectors 17-n7 may also be housed in the thermostat ovens 16-n6, respectively, depending on the structure of the detectors 17-n7.

Although in the embodiment each of the analysis modules 1-n is equipped with one analysis unit which consists of a column for separating components of a sample and a detector for detecting the components separated by the column, the invention is not limited to such a case. For example, as shown in FIG. 4, an analysis module p may be equipped with a first analysis unit which consists of a column p41 and a detector p71 and a second analysis unit which consists of a column p42 and a detector p72.

In the analysis module p having the configuration of FIG. 4, the same target sample selected from plural (m) samples by a sample selector p5 is injected into each of the two analysis units by a prescribed amount via a sample injector p3.

The two analysis units are controlled so as to operate in different analysis cycles that correspond to different separation times of two respective components. As a result, the two components can be analyzed parallel and simultaneously by the single analysis module p and hence the times taken to analyze an early separation component can be shortened greatly.

Three or more analysis units may be incorporated in one analysis module. In this case, it need not always be the case that the analysis units analyze the same sample. That is, the analysis units may either operate so as to analyze different samples or operate in such a manner that some of them analyze the same sample in different analysis cycles and the other analyze different samples. In this manner, operation modes of the respective analysis units may be combined arbitrarily.

Although the above embodiments are directed to a gas chromatograph, the application range of the invention is not limited to a gas chromatograph but encompasses various kinds of chromatographs.

As is understood from the above description, the invention can realize a chromatograph which can shorten the analysis time of plural samples and the analysis times of early separation components.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. A chromatograph comprising:
at least two analysis modules each comprising:
a column that separates components of a sample; and
a detector that detects the components separated by the column,
wherein each of the analysis modules analyzes the sample in an analysis cycle that is set for each of the analysis modules.

2. The chromatograph of claim 1, wherein the analysis modules analyze the same sample in the analysis cycles.

3. The chromatograph of claim 1, wherein the analysis modules analyze different samples in the analysis cycles.

4. The chromatograph of claim 1, wherein each of the analysis cycles is different for each of the analysis modules.

5. A chromatograph comprising:
a first analysis module configured to analyze a first sample in a first cycle, the first analysis module comprising:
a first column that separates components of the first sample; and
a first detector that detects the components separated by the first column; and
a second analysis module configured to analyze a second sample in a second cycle different from the first cycle, the second analysis module comprising:
a second column that separates components of the second sample; and
a second detector that detects the components separated by the second column.

6. The chromatograph of claim 5, wherein the first sample is the same as the second sample.

7. The chromatograph of claim 5, wherein the first sample is different from the second sample.
